(19) United States
(12) Patent Application Publication
(10) Pub. No.: US 2014/0115725 A1
(43) Pub. Date: Apr. 24, 2014

(54) FILE USING RESTRICTION METHOD, USER DEVICE AND COMPUTER-READABLE STORAGE

(71) Applicants: CRUCIALSOFT COMPANY, Seoul (KR); CRUCIALTEC CO., LTD., Chungcheongnam-do (KR)

(72) Inventors: Jong Chul SEO, Gyeonggi-do (KR); Hyo Min JOO, Gyeonggi-do (KR); Sang Min MUN, Seoul (KR); Jae Han KIM, Gyeonggi-do (KR)

(73) Assignees: CRUCIALSOFT COMPANY, Seoul (KR); CRUCIALTEC CO., LTD., Chungcheongnam-do (KR)

(21) Appl. No.: 14/058,272

(22) Filed: Oct. 20, 2013

(30) Foreign Application Priority Data
Oct. 22, 2012 (KR) 10-2012-0117452
Oct. 22, 2012 (KR) 10-2012-0117453

(51) Int. Cl. G06F 21/62; G06F 3/0488

(52) U.S. Cl. CPC G06F 21/6209; G06F 3/04883
USPC 726/30

(57) ABSTRACT

Provided are a method of restricting the use of a file, an electronic device, and a recording medium. The method of restricting the use of the file includes receiving an input of setting a region by a touch drag operation or a touch draw operation on a screen, receiving an input of a fingerprint of a user, and setting a lock on at least one file included in the region by matching the at least one file and the input of the fingerprint.

### CROSS-REFERENCE TO RELATED APPLICATION

This application claims priority to and the benefit of Korean Patent Application No. 2012-117452, filed on Oct. 22, 2012, and Korean Patent Application No. 2012-117453, filed on Oct. 22, 2012, the disclosure of which is incorporated herein by reference in its entirety.

### BACKGROUND

1. Field of the Invention

The present invention relates to a method of restricting the use of a file, an electronic device, and a recording medium, and more particularly, to a method of restricting the use of a file existing in a set lock region, an electronic device, and a recording medium.

2. Discussion of Related Art

In recent years, various additional functions utilizing personal information such as mobile banking have been provided through mobile communication terminals in addition to communication functions such as phone services or text message transmission services.

Thus, there is an urgent need for a lock device for the mobile communication terminal.

Most existing lock devices applied to the mobile communication terminals perform typical methods using passwords.

For example, in a typical method, the lock device is applied to a phone function, an additional function, an international calling function, or the like, and a corresponding password should be input in order to use the corresponding function.

However, there are disadvantages in that the method is useless when the password is exposed, the password should be regularly changed in order to ensure stability, a user should remember the password, and the like.

Thus, in recent years, in order to supplement the above-described method and improve locking effects, a terminal in which a lock device using fingerprint recognition is mounted has been developed in earnest.

In order for such a fingerprint recognition apparatus to be mounted in a mobile communication terminal which is manufactured to be small, a size of a corresponding sensor should be minimized In accordance with this need, a “sliding type” fingerprint recognition sensor that recognizes a fingerprint when a corresponding finger is swiped on a sensor which is provided in the form of a laterally long bar has been developed.

Meanwhile, as fingerprint recognition sensors come to be mounted on mobile communication terminals, efforts to graft other functions onto the fingerprint recognition sensor are being made.

### SUMMARY

The present invention is directed to a method in which a lock region is set on a screen and then locking is set on a file included in the lock region using a fingerprint, an electronic device, and a recording medium.

In addition, the present invention is directed to a method in which a lock region is set on a screen using a fingerprint and then locking is set on a file dragged into the locked region, an electronic device, and a recording medium.

Meanwhile, the present invention is directed to a method of restricting use of a file so that locking is released only through a corresponding fingerprint with respect to a file on which locking is set, an electronic device, and a recording medium.

According to an aspect of the present invention, there is provided a method of restricting use of a file, including: receiving an input of setting a region by a touch drag operation or a touch draw operation on a screen; receiving an input of a fingerprint of a user; and setting a lock on at least one file included in the region by matching the at least one file and the input of the fingerprint.

In this instance, the receiving the input of the fingerprint may include setting the region as a locked region, and wherein the setting the lock may include, dragging a file into the locked region and setting the lock on the file by matching the file and the input of the fingerprint.

Also, the receiving the input of setting the region may include displaying a locked region setting means capable of enlarging or reducing the region by the touch drag operation on the screen.

Also, the method may further include: displaying the file on which set the lock on the screen; receiving and sensing, when a target file on which is released the lock among the displayed files is selected or dragged out of the region, an input of a fingerprint for releasing the lock of the selected file; and releasing the lock of the target file when the sensed fingerprint is authenticated.

According to another aspect of the present invention, there is provided a computer readable recording medium in which a program for executing the above- described method is recorded.

According to still another aspect of the present invention, there is provided an electronic device for restricting use of a file, including: a locked region setting unit that receives an input of setting a region by a touch drag operation or a touch draw operation on a screen; a fingerprint sensor unit that receives an input of a fingerprint of a user; and a file locking management unit that sets a lock on at least one file included in the region by matching the at least one file and the input of the fingerprint.

In this instance, the region may be set as a locked region by the input of the fingerprint, and when dragging a file into the locked region, the file locking management unit may set the lock on the file by matching the file and the input of the fingerprint.

Also, the locked region setting unit may display a locked region setting means capable of enlarging or reducing the region by the touch drag operation on the screen.

Also, when a target file on which is released the lock among the files is selected or dragged out of the region, the fingerprint sensor unit may receive and sense an input of a fingerprint for releasing the lock of the selected file.

Also, the file locking management unit may release the lock of the target file when the sensed fingerprint is authenticated.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 illustrates a structure of an electronic device 100 according to an embodiment of the present invention;

FIG. 2 illustrates an example of a fractional fingerprint image obtained by a sliding fingerprint sensor unit 120 shown in FIG. 1;

FIG. 3 is a block diagram illustrating a configuration of an electronic device 100 according to an embodiment of the present invention;

FIG. 4A illustrates a process of restricting use of a file according to an embodiment of the present invention;

FIG. 4B illustrates a process of restricting use of a file according to a modified embodiment of FIG. 4A;

FIG. 5A illustrates a process of restricting use of a file according to another embodiment of the present invention; and

FIG. 5B illustrates a process of restricting use of a file according to a modified embodiment of FIG. 5A.

### DETAILED DESCRIPTION OF EXEMPLARY EMBODIMENTS

Example embodiments of the present invention are disclosed herein. However, specific structural and functional details disclosed herein are merely representative for purposes of describing example embodiments of the present invention, and example embodiments of the present invention may be embodied in many alternate forms and should not be construed as being limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Hereinafter, embodiments of the present invention will be described in detail with reference to the accompanying drawings.

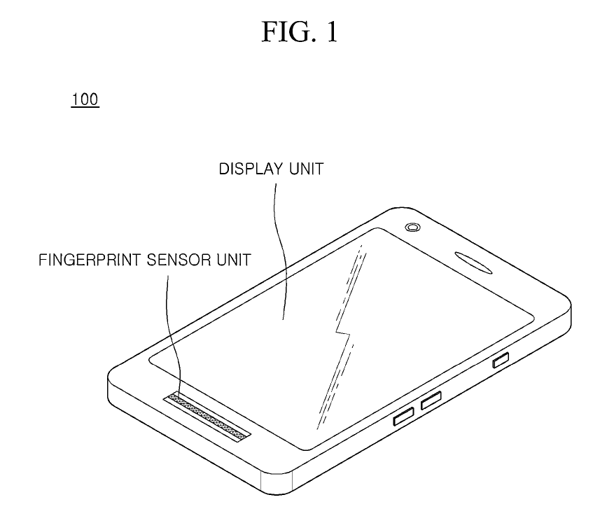

FIG. 1 illustrates a structure of an electronic device 100 according to an embodiment of the present invention.

Referring to FIG. 1, the electronic device 100 according to an embodiment of the present invention may include a fingerprint sensor unit in at least a portion thereof

In FIG. 1, a case in which the fingerprint sensor unit is formed in a side edge of the electronic device 100 is shown, but the fingerprint sensor unit can be formed in any position without departing from the scope of the present invention.

The electronic device 100 according to an embodiment of the present invention may be a digital device that performs a user's desired operation by performing predetermined data processing.

In addition, the electronic device 100 may include an input unit and a display unit, and provide a state with respect to an operation performed by a predetermined operation instruction of the user through the input unit to the user through the display unit.

In FIG. 1, an example in which the display unit of the electronic device 100 is implemented in a touch screen method and the display unit itself simultaneously acts as the input unit is illustrated, but the input unit may be implemented in a keyboard or keypad method and provided separately from the display unit.

The electronic device 100 according to an embodiment of the present invention should be understood as an encompassing term including digital devices which include a memory means performed in a touch screen method and have a microprocessor mounted therein for computing power, such as tablet PCs, smartphones, PDAs, web pads, mobile phones, navigation systems, digital cameras, and the like.

In addition, the electronic device 100 according to another embodiment of the present invention should be understood as an encompassing term including devices in which a separate fingerprint recognition device is connected to a personal computer (PC), a workstation, or the like.

The fingerprint sensor unit according to an embodiment of the present invention may be implemented as a sliding type. The sliding type fingerprint sensor unit performs fingerprint recognition in such a manner that fragmentary fingerprint images are read by sensing a fingerprint of a finger which slidably moves and then the read fragmentary fingerprint images are matched to a single image to implement a complete fingerprint image.

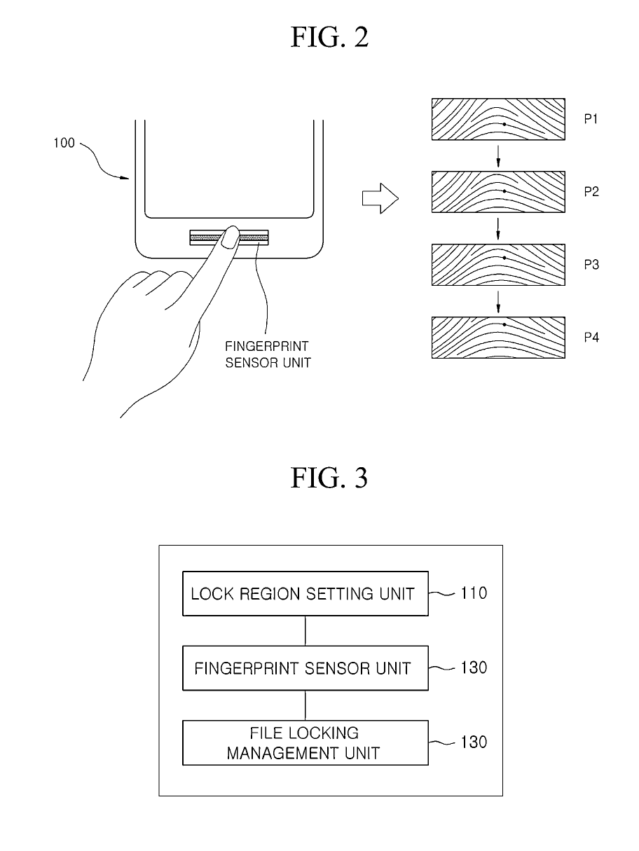

FIG. 2 illustrates an example of fractional fingerprint images obtained by a sliding fingerprint sensor unit 120 shown in FIG. 1.

For example, when a user slidably moves his or her thumb on the fingerprint sensor unit, partial fractional images P1 to P4 are consecutively obtained.

That is, fingerprint images of the user are sequentially obtained in a fractional but mutually consecutive manner.

The fractional fingerprint images read from the fingerprint sensor unit are matched to a single fingerprint image.

According to an embodiment, the matched fingerprint image is compared with a fingerprint image registered in advance, and is used as a means for confirming the authenticity of the user.

That is, user authentication may be performed in such a manner that the registered fingerprint image of the user may be stored in a database (not shown) of the electronic device 100 and the corresponding fingerprint image obtained by the fingerprint sensor unit may be compared with the registered fingerprint image stored in the database.

According to another embodiment, the matched fingerprint image may be compared with at least one fingerprint image registered in advance, and act as an instruction for performing a specific operation.

For example, specific operations are matched with fingerprints of each finger of the user and stored, and when the matched fingerprint image obtained by the fingerprint sensor unit coincides with a fingerprint image of a specific finger, a specific operation matched with this may be performed. This is called a “quick launching” function.

For example, the user may perform setting in advance in such a manner that a first application is driven when a thumb fingerprint of a true user is recognized and a second application is driven when an index fingerprint of the user is recognized.

Thereafter, when the user slidably moves his or her thumb on the fingerprint sensor unit and the matched fingerprint image obtained by the fingerprint sensor unit coincides with a thumb fingerprint image registered in advance, an operation matched with this, that is, a driving operation of the first application, may be performed.

FIG. 3 is a block diagram illustrating a configuration of an electronic device 100 according to an embodiment of the present invention.

The electronic device 100 according to an embodiment of the present invention may include a lock region setting unit 110, a fingerprint sensor unit 120, and a file locking management unit 130.

For reference, the file of the present invention is not limited by the filename extension of a file such as an image file, a moving image file, a compressed file, a document file, and the like, and may include icons for executing applications.

The lock region setting unit 110 may receive an input of a region (hereinafter referred to as “lock region”) set by a touch drag operation or a touch draw operation on a screen.

In this instance, the lock region setting unit 110 may display, on the screen, a lock region setting means capable of enlarging or reducing the lock region by the touch drag operation when the lock region is input through the touch drag.

Here, the “lock region setting means” may have a rectangular box shape, and a user may set a region with a desired size by performing a touch drag operation on an edge portion of the lock region setting means.

For reference, the lock region setting means is not limited to the above-described box shape, and may have various shapes.

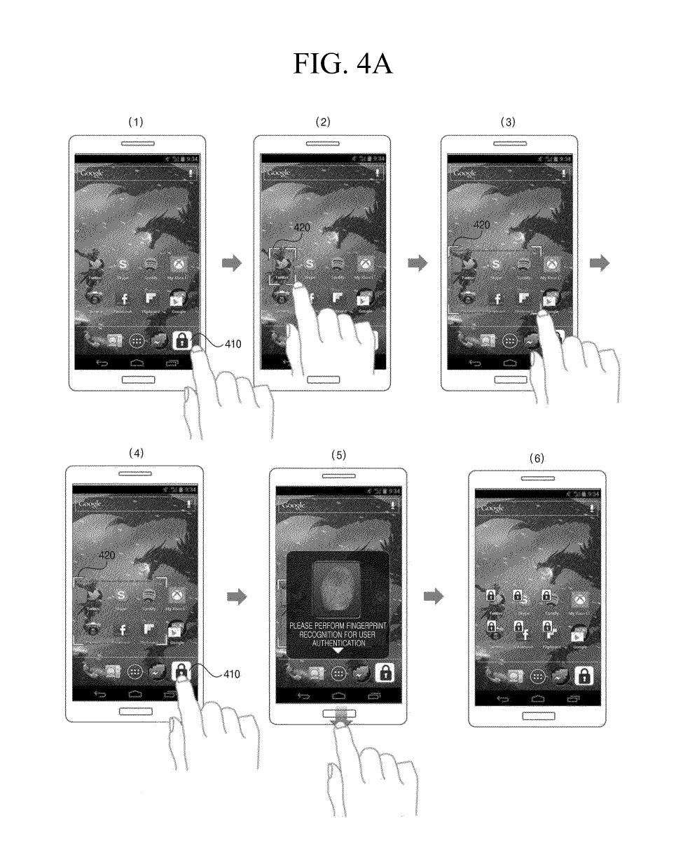

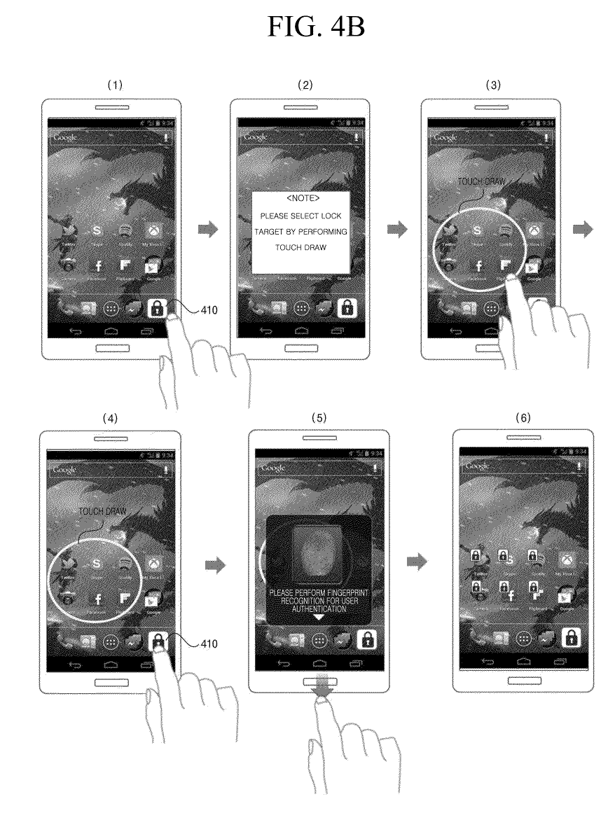

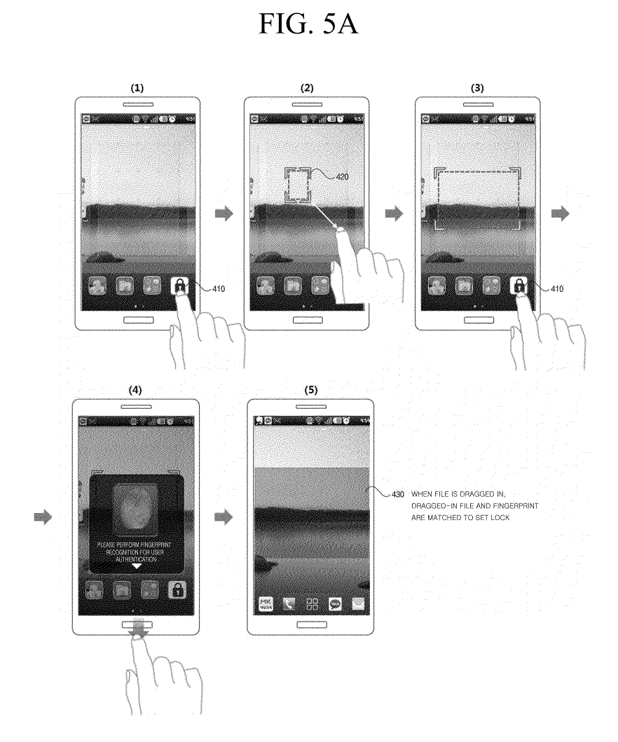

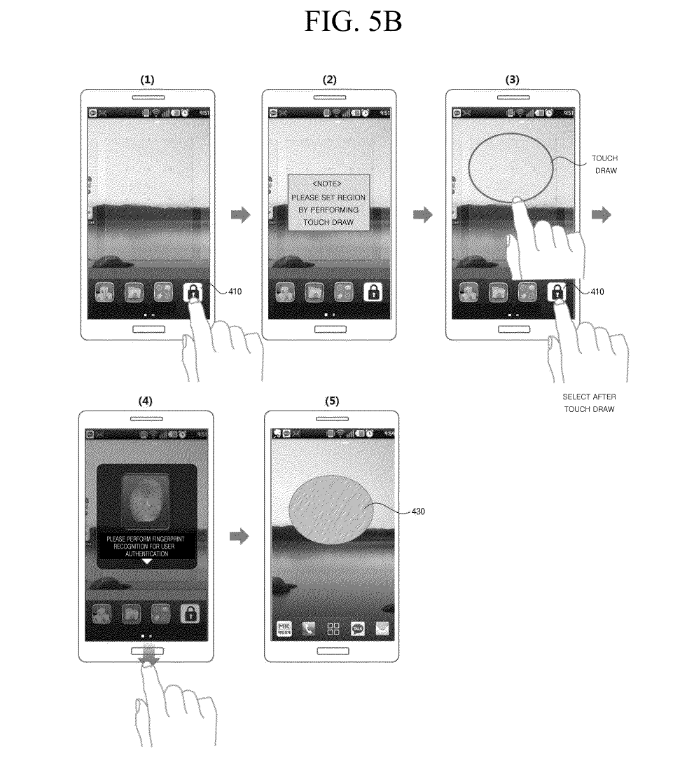

Detailed description thereof will be described later with reference to FIGS. 4A, 4B, 5A, and 5B.

In addition, when a fingerprint is registered through the fingerprint sensor unit 120 which will be described later, the lock region setting unit 110 may set the input region as a locked region.

Meanwhile, the fingerprint sensor unit 120 may sense the input of the fingerprint in order to set a lock on a file or set the region as the locked region, and sense the input of the fingerprint in order to release the locking of the file on which locking is set.

Detailed descriptions of fingerprint sensing have been described above and thus will be omitted here.

Meanwhile, the file locking management unit 130 may determine whether the file is included in the lock region set by the touch drag operation or touch draw operation of the user, and set a lock on at least one file included in the lock region by matching the fingerprint sensed by the fingerprint sensor unit 120 with the at least one file included in the lock region.

Here, the “file is included in the lock region” may mean that the lock region set by the touch drag operation or the touch draw operation overlaps the file displayed on the screen, and the lock region may overlapped all or a part of the file displayed on the screen.

In this instance, the file locking management unit 130 may recognize a corresponding file as being included in the lock region when only a part of the corresponding file is included in the lock region or only when all of the corresponding file is included in the lock region.

In addition, according to another embodiment, dragging a file into the locked region set by the user, the file locking management unit 130 may set a lock on the dragged-in file by matching the corresponding file and the fingerprint sensed by the fingerprint sensor unit 120.

In this instance, when the number of the dragged-in files is plural, the file locking management unit 130 may simultaneously set a lock on the plurality of files by matching the plurality of files and the sensed fingerprint.

The file locking management unit 130 may display a locking state with respect to the file on which locking has been set.

Meanwhile, when there is a request to release the locking of the file on which locking has been set, the file locking management unit 130 may release the locking of the corresponding file. In this instance, when there are requests to release the locking of each of the plurality of files, the file locking management unit 130 may simultaneously release the locking of the plurality of files.

For reference, the request to release the locking of the file may be performed by selecting (touching) the file whose locking state is displayed, performed by selecting the plurality of files whose locking states are displayed using the touch drag or the touch draw (enabling the plurality of files to be included in the lock region), or performed by dragging the file displayed in the locking state out of the lock region. In a method of dragging the corresponding file out of the lock region, when the plurality of files are dragged out of the lock region in a case in which there is a request to release locking, the file locking management unit 130 may simultaneously release the locking of the plurality of corresponding files.

That is, the electronic device 100 of the present invention may simultaneously set a lock on a plurality of files using a single fingerprint, and simultaneously release the locking of the plurality of files on which locking has been set using a single fingerprint.

FIG. 4A illustrates a process of restricting use of a file according to an embodiment of the present invention.

Referring to (1) of FIG. 4A, the electronic device 100 displays a separate button 410 on a screen in order to provide a function of restricting use of a file according to the present invention.

When a corresponding button 410 is selected by a user, the electronic device 100 displays a lock region setting means 420 on a screen as shown in (2) of FIG. 4A.

As shown in (3) of FIG. 4A, the user may adjust a size of the lock region by performing a touch drag operation on an edge portion of the lock region setting means 420 displayed on the screen so that a file to be locked is included in the lock region.

When the button 410 is selected again by the user as shown in (4) of FIG. 4A after the file to be locked is determined, the electronic device 100 requests a fingerprint input for setting a lock on files included in the lock region as shown in (5) of FIG. 4A.

For reference, when a fingerprint of the user is input in advance, the process of registering the fingerprint shown in (5) of FIG. 4A can be omitted.

Next, when the fingerprint is input, the electronic device 100 may set a lock on the file included in the lock region, and display a locking state as shown in (6) of FIG. 4A.

Next, when the file whose locking state is displayed is selected, the electronic device 100 may request a fingerprint input, and when the fingerprint is input and user authentication is completed, the electronic device 100 may release locking of a corresponding file.

FIG. 4B illustrates a process of restricting use of a file according to a modified embodiment of FIG. 4A.

Referring to (1) of FIG. 4B, the electronic device 100 displays a separate button 410 on a screen in order to provide a function of restricting use of a file according to the present invention.

As shown in (2) of FIG. 4B, when a corresponding button 410 is selected by a user, the electronic device 100 displays a message for requesting setting of a lock region on the screen.

As shown in (3) of FIG. 4B, the user may set a size of the lock region through a touch draw, and adjust the size of the lock region so that a file to be locked is included in the lock region.

When the button 410 is selected again by the user as shown in (4) of FIG. 4B after the file to be locked is determined, the electronic device 100 requests a fingerprint input for setting a lock on files included in the lock region as shown in (5) of FIG. 4B.

For reference, when a fingerprint of the user is input in advance, the process of registering the fingerprint shown in (5) of FIG. 4B can be omitted.

Next, when the fingerprint is input, the electronic device 100 may set a lock on the file included in the lock region, and display a locking state as shown in (6) of FIG. 4B.

Next, when the file whose locking state is displayed is selected, the electronic device 100 may request a fingerprint input, and when user authentication is completed through the input of the fingerprint, the electronic device 100 may release the locking of the corresponding file.

Hereinafter, a process of restricting use of a file according to another embodiment of the present invention will be described.

FIG. 5A illustrates a process of restricting use of a file according to another embodiment of the present invention.

Referring to (1) of FIG. 5A, the electronic device 100 displays a separate button 410 on a screen in order to provide a function of restricting use of a file according to the present invention.

When the corresponding button 410 is selected by a user, the electronic device 100 displays a lock region setting means 420 on the screen as shown in (2) of FIG. 5A.

As shown in (3) of FIG. 5A, the user may adjust a size of a region to be set as the locked region by performing a touch drag operation on an edge portion of the lock region setting means 420 displayed on the screen.

Next, when the button 410 is selected again by the user, the electronic device 100 requests a fingerprint input for setting a region input by the lock region setting means 420 as the locked region as shown in FIG. 4) of FIG. 5A.

For reference, when a fingerprint of the user is input in advance, the process of registering the fingerprint shown in (4) of FIG. 5A can be omitted.

Next, when the fingerprint is input, the electronic device 100 sets the region input in (3) of FIG. 5A as the locked region 430 as shown in (5) of FIG. 5A.

In this instance, the electronic device 100 may display the lock region 430 by displaying or emitting a specific color, and a method of displaying the lock region 430 of the electronic device 100 is not limited to the above-described example.

Next, dragging a file into the locked region 430, the electronic device 100 sets a lock on the corresponding file by matching the fingerprint input in (4) of FIG. 5A and the dragged-in file.

Next, the electronic device 100 may display a locking state with respect to a plurality of files on which locking has been set.

Next, when the file whose locking state has been displayed is selected or dragged out of the lock region 430, the electronic device 100 requests a fingerprint input.

Next, when the fingerprint is input and user authentication is completed, the electronic device 100 may release the locking of the corresponding file.

a. FIG. 5B illustrates a process of restricting use of a file according to a modified embodiment of FIG. 5A.

Referring to (1) of FIG. 5B, the electronic device 100 displays a separate button 410 on a screen in order to provide a function of restricting use of a file according to the present invention.

When the corresponding button 410 is selected by the user, the electronic device 100 displays a message for requesting setting of a lock region on the screen as shown in (2) of FIG. 5B.

As shown in (3) of FIG. 5B, the user may input a region to be set as the locked region through a touch draw.

Next, when the button 410 is selected again by the user, the electronic device 100 requests a fingerprint input for setting the region input through the touch draw as the locked region as shown in (4) of FIG. 5B.

For reference, when a fingerprint of the user is input in advance, the process of registering the fingerprint shown in (4) of FIG. 5B can be omitted.

Next, when the fingerprint is input, the electronic device 100 sets the region input in (3) of FIG. 5B as the locked region 430 as shown in (5) of FIG. 5B.

The subsequent process of restricting the use of the file is the same as the process described with reference to FIG. 5A, and thus will be omitted.

As described above, according to the method of restricting the use of the file, the electronic device, and the recording medium according to the embodiments of the present invention, a region may be set using a touch, and lock on at least one file included in the region may be easily set using fingerprints.

In addition, a corresponding file may be dragged into a locked region using fingerprints, thereby simply setting a lock on the file.

In addition, fingerprints may be used when releasing locking of a file on which locking has been set, thereby attaining effective file access security.
a. It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

1. A method of restricting use of a file, comprising:
receiving an input of setting a region by a touch drag operation or a touch draw operation on a screen;
receiving an input of a fingerprint of a user; and
setting a lock on at least one file included in the region by matching the at least one file and the input of the fingerprint.

2. The method of claim 1, wherein the receiving the input of the fingerprint includes setting the region as a locked region, and wherein the setting the lock includes, dragging a file into the locked region and setting the lock on the file by matching the file and the input of the fingerprint.

3. The method of claim 1, wherein the receiving the input of setting the region includes displaying a lock region setting means capable of enlarging or reducing the region by the touch drag operation on the screen.

4. The method of claim 1, further comprising:
displaying the file on which set the lock on the screen;
receiving and sensing, when a target file on which is released the lock among the displayed files is selected or dragged out of the region, an input of a fingerprint for releasing the lock of the selected file; and
releasing the lock of the target file when the sensed fingerprint is authenticated.

5. A computer readable recording medium in which a program for executing the method according to claim 1 is recorded.

6. An electronic device for restricting use of a file, comprising:
a lock region setting unit that receives an input of setting a region by a touch drag operation or a touch draw operation on a screen;
a fingerprint sensor unit that receives an input of a fingerprint of a user; and
a file locking management unit that sets a lock on at least one file included in the region by matching the at least one file and the input of the fingerprint.

7. The electronic device of claim 6, wherein the region is set as a locked region by the input of the fingerprint, and when dragging a file into the locked region, the file locking management unit sets the lock on the file by matching the file and the input of the fingerprint.

8. The electronic device of claim 6, wherein the lock region setting unit displays a lock region setting means capable of enlarging or reducing the region by the touch drag operation on the screen.

9. The electronic device of claim 6, wherein, when a target file on which is released the lock among the files is selected or dragged out of the region, the fingerprint sensor unit receives and senses an input of a fingerprint for releasing the lock of the selected file.

10. The electronic device of claim 9, wherein the file locking management unit releases the lock of the target file when the sensed fingerprint is authenticated.

11. A computer readable recording medium in which a program for executing the method according to claim 2 is recorded.

12. A computer readable recording medium in which a program for executing the method according to claim 3 is recorded.

13. A computer readable recording medium in which a program for executing the method according to claim 4 is recorded.
